(19) United States
(12) Patent Application Publication
(10) Pub. No.: US 2007/0220016 A1
(43) Pub. Date: Sep. 20, 2007

(54) Secured content syndication on a collaborative place

(76) Inventors: Antonio Estrada, Nashua, NH (US); Ian M. Connor, Concord, MA (US); Sami M. Shalabi, Winchester, MA (US)

Correspondence Address: Brown Raysman Millstein Felder & Steiner LLP, 900 Third Avenue, New York, NY, 10022, US

(21) Appl. No.: 11/305,792

(22) Filed: Dec. 16, 2005

(51) Int. Cl. G06F 17/30; G06F 7/00

(52) U.S. Cl. 707/100; 707/10

(57) ABSTRACT

A method and computer program product for facilitating delivery of syndicated content to a user of a secured collaborative place in a collaborative computer environment, comprising receiving a request for syndicated content, and providing syndicated content based on at least one credential associated with the user, the syndicated content being associated with the secured collaborative place. Secured content syndication on a collaborative place may be provided as RSS feeds. A user can receive contents of the collaborative place filtered by the authenticated user credentials, thus allowing the user to only view content that the user has credentials to read in the collaborative place.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

1. Field of the Invention

The present invention relates to collaborative computing, and more particularly to providing secured content syndication in a collaborate environment.

2. Background Art

Collaborative computing provides a means for users to pool their strengths and experiences to achieve a common goal. For example, a common goal may be the completion of a software development project or even creation and use of a system to manage human resources. A collaborative computing environment may be defined by (1) a particular context, i.e., the objective of the environment, (2) membership, i.e., the participants in the environment and their roles, and (3) and tools and resources used in the context. Individuals in the environment may be assigned roles or other name which may dictate access to the resources and tools within the environment and which may also define the behavior of the community members. For instance, in a business project collaborative environment, a team member who is the leader of the collaborative environment may be designated an administrator role, thus having access to all resources, and the ability to select members, specify their roles, and specify access and privileges according to roles and/or identity. Alternatively, an individual designated a reviewer may not have access to working documents within the environment, as the reviewer may be involved in reviewing final documents and precluded from modification and approval processes.

Collaborative computing environments are customized to meet the developers' and users' needs. For example customized collaborative computing environments such as team workspaces, e-meetings, virtual classrooms and communities are known. Each of these types of environments is implemented using shared resources as a building block to create the environment. Shared resources for all environments have general characteristics such as a purpose/title, and the premise that they can be created, deleted, cloned, renamed, expired, archived and restored, etc. Shared resources may also be customized to fulfill the objectives of the environment.

In a web-based collaboration environment, when team members want to collaborate on a given project, they must navigate to the workspace using a web browser, sign in if the workspace is not setup to allow anonymous access, and collaborate—read content, respond to content, create new content—via various methods provided by the workspace. Further, team members having different access rights within the workspace must navigate to the workspace to ascertain whether any content has been modified (e.g., new document created, document edited, workflow process requiring action, etc.), as collaborative environments lack any mechanism for selectively notifying users of content changes according to their access rights within the workspace.

Although content syndication (e.g., via RSS feeds) has become a widely used technology for notifying individuals of content changes at websites, all collaborative environments providing content via RSS provide public anonymously readable content.

### SUMMARY OF THE INVENTION

The present invention addresses the above-mentioned and other limitations of the background art by providing, inter alia, a method and system for providing secured content syndication. A user may receive contents of a collaborative place filtered by the authenticated user credentials, thus allowing the user to only view content that the user has credentials to read in the collaborative place. Secured content syndication on a collaborative place may be provided as RSS feeds.

In accordance with a first aspect of the present invention, a method for facilitating delivery of syndicated content to a user of a secured collaborative place in a collaborative computer environment comprises receiving a request for syndicated content, and providing syndicated content based on at least one credential associated with the user, the syndicated content being associated with the secured collaborative place. A credential may be the user identity itself, associated with the user identity, and/or based on a role of the user in the collaborative place.

In accordance with another aspect of the present invention, providing syndicated content based on at least one credential associated with the user comprises, in response to the request, filtering syndicated content available on the secured collaborative place according to the at least one credential. A database having content associated with the secured collaborative place may be selectively read according to the at least one credential.

In accordance with still another aspect of the present invention, a computer program product comprises a computer program embodied on at least one computer readable medium, the computer program when executed being operative in performing the method recited above according to a first aspect of the present invention.

Additional aspects of the present invention will be apparent in view of the description which follows.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a block diagram schematically depicting a named collaborative space created to provide secured syndicated content, in accordance with an embodiment of the present invention;

FIG. 2 schematically depicts a collaborative computing system that provides a collaborative environment in which a secured collaborative space may be implemented to provide syndicated content delivery from the space to the users based on user credentials, in accordance with an embodiment of the present invention;

FIG. 3 is an flowchart of an illustrative process for a user to subscribe to syndicated content from a collaborative workspace, in accordance with an embodiment of the present invention; and

FIG. 4 is a flowchart of an illustrative process for providing syndicated content from a collaborative workspace, in accordance with an embodiment of the present invention.

### DETAILED DESCRIPTION

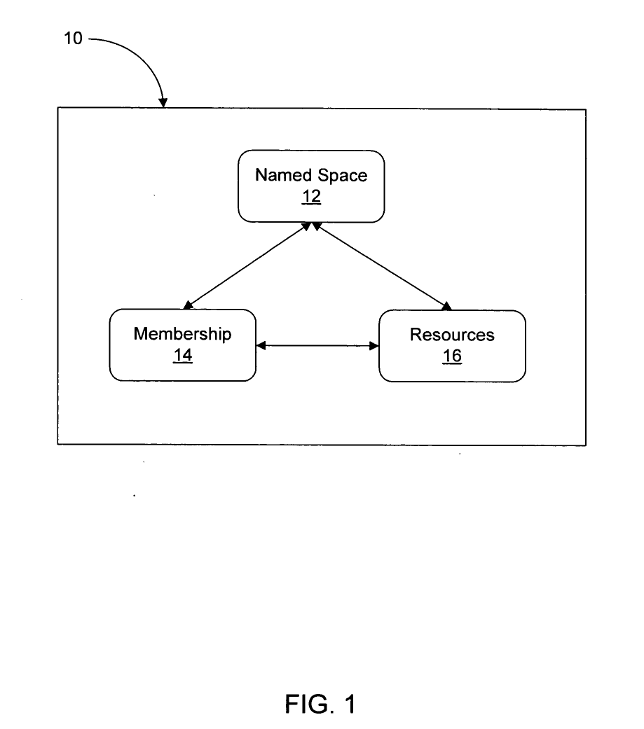

FIG. 1 is a block diagram schematically depicting a secure named collaborative space 10 implemented in a collaborative computing environment in which syndicated content filtered by authenticated user credentials may be provided according to an embodiment of the present invention. Collaborative space 10 includes named space 12, membership 14, and resources 16, each of which interoperate with each other to provide the framework for secure collaborative space 10.

Named space 12 refers to the community place (also referred to herein as work place) within which the membership and processes exist. For instance, a named space 12 can be a portal place within a collaborative computing environment. Hereinbelow, a named collaborative space is also referred to by various terms such as “project space,” “space,” “work space,” and “place”; however, it is understood that such terminology, as used herein, does not impart any special or particular meaning to the collaborative environment, such as how it is generated or configured, for what purpose it is used, what tools are available therein, or other characteristics of the collaborative environment.

Resources 16 is implemented as one or more resource or tool instances within named space 12, providing the tools and resources used by membership 14. Examples of resources and/or tools provided by Resources 16 include search engines, discussion forums, document libraries, to-do tasks, meeting schedulers, calendar events, etc.

Membership 14 refers to the individuals within the named collaborative space, namely, the users of space resources 16 within named space 12. Members of the named collaborative space may have assigned roles, and these roles may dictate access to the resources instances, namely, the resources and tools. For example, roles within a named collaborative space instance relating to a software development project might include managers, programmers assigned to different components of the software, technical writers, and other members having certain responsibilities. Access privileges to various resources and tools (e.g., documents, discussion forums, approval and review processes, etc.) may be assigned according to a user's credentials, and such credentials may be based on the user's identity, and alternatively or additionally based on roles.

As will be further understood from the ensuing description, in accordance with embodiments of the present invention, the collaborative space is configured to provide syndicated content concerning the space resources 16 to its members, with the syndicated content being filtered according to user credentials. In some embodiments, the syndicated content is filtered according to user credentials that are applicable to other access control and privileges within the space, such as according to the member's identity and/or assigned roles. It may be understood, however, that the filtering of syndicated content may be based on additional or alternative credentials associated with each member, as the degree of granularity for filtering syndicated content may differ from that for other access and privilege control. It will be further understood by those skilled in the art that such credential based filtering of syndicated content according to various embodiments of the present invention may be provided by the access control logic and processes within the collaborative computing environment such as those which are used to implement and enforce access and permission policy relating to community roles. Alternatively, or additionally, the filtering may be provided by separate control logic and process.

As understood from the foregoing, named collaborative space 10 represents a secure named instance within a collaborative environment. A secure collaborative space may be implemented in various ways; for instance, such a collaborative space may be created using commercial products such as the IBM QuickPlace application of the IBM Workplace™ Collaboration Services software product. QuickPlace is a web-based application that allows users (e.g., team members) to create a secure work place (e.g., site) that contains the tools (discussions, libraries, folder repositories, custom forms, workflow, custom logic via agents, online chat, calendars, task tracking, membership, inner places hierarchies, etc.) they need to collaborate on a given project via a web browser. Each team's space can operate with security that is as granular as the sensitivity of the material and the size that the team requires. For instance, team leaders may conduct a discussion that cannot be seen by other members of the team. As understood by those skilled in the art, content that may be syndicated in a collaborative place such as that created by QuickPlace includes one or more of the following: new documents within a precedent time period (e.g., since last visit to the site, in the last day, etc.; leveraging the existing What's New feature of QuickPlace); places that the user has been given access to (e.g., leveraging the My Places feature of QuickPlace); documents within a specific folder in the place; to-do tasks within the place; calendar events within the place; and emails received by the place.

It is understood, however, that a secure collaboration place in accordance with various embodiments of the present invention is not limited to any particular collaboration product, platform, tools, or environment, etc. For instance, in some embodiments of the present invention, a collaborative space may be implemented as a wiki, a collaborative blog, or other network-based secure collaborative space which may be configured such that syndicated content may be filtered according to member identity or other user credentials.

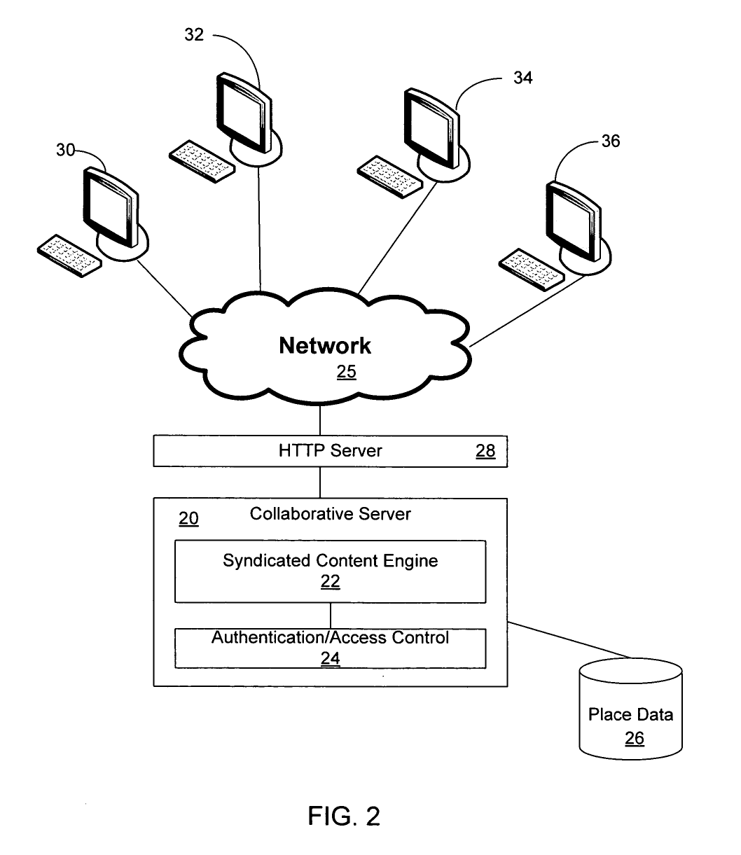

FIG. 2 schematically depicts a collaborative computing system that provides a collaborative environment in which a secured collaborative space 10 may be implemented to provide syndicated content delivery from the space to the users (e.g., team members) based on user credentials, in accordance with an illustrative embodiment of the present invention. As shown, collaborative computing system includes a collaborative server 20 communicatively coupled to a place database 26 and to a HTTP based server 28 (e.g., a web server), and a network 25 communicatively coupled to web server 28 and to user devices 30, 32, 34, 36.

Network 25 represents any configuration of public and/or private networks such as, for example, a LAN, a WAN, a public switched telephone network, a wireless network, or the Internet. HTTP server 28 provides an HTTP interface to the collaborative server through which user devices 30, 32, 34, 36 may visit the place. Place database 26 includes all information associated with the place, such as configuration data, work place content and related data (e.g., project data accessed and/or generated by team members), and place metadata. It is appreciated, however, that such information stored about the place may be logically and/or physically distributed over different databases and storage devices.

Collaborative server 20 services provide for place creation, management, and operation. More generally, collaborative server 20 may be part of a multi-server environment having access to multiple databases to service (e.g., including creating a place, and providing all resources available in a given place) and aggregate data for each place provided in the collaborative environment. Collaborative server 20 is shown as including an authentication and access control module 24, which is operative in user sign-on authentication. In some embodiments, each user of a given place may be assigned not only a unique identifier for signing onto the place, but may also be assigned to one or more roles within the place. Each user's access rights and privileges in the place may be dependent on the role assigned to the user. Such access control data (e.g., access control lists indexed according to user identity) is stored in place database 26, and may be accessed by authentication and access control module 24.

Collaborative server 20 also includes a syndicated content engine 22, which is operative in serving syndicated content associated with the place to team members. In this illustrative embodiment, the place is configured to produce RSS (Really Simple Syndication, or Rich Site Summary, or RDF Site Summary) feeds for the place, although other types of feeds (e.g., Atom) may be alternatively or additionally provided. Additionally, it will be understood that secure content syndication for a place in accordance with the present invention is not limited to XML-based format for content distribution. Syndicated content engine generates the feeds for new or modified content (e.g., documents, workflows, messages, etc.) within the place. In some implementations, resource instances within the place may themselves generate RSS feeds, and syndicated content engine 22 (also referred to in this embodiment as RSS engine 22) may also itself aggregate these feeds provided by the resource instances within the place. Although a single feed for all content in the place may be provided, alternatively or additionally, separate feeds (channels) may be provided for different resources (e.g., documents, work processes, etc.). For each item of new or modified content, a feed typically may at least describe a title, link (e.g., URL), and a brief description. Content may also include links to pages within or outside the place, such as links that a user may have posted to documents in the place. In accordance with the present invention, syndicated content engine 22 serves content (e.g., provides an RSS feed) to a user such that the content is dependent on the credentials of the user. Accordingly, a user may only receive syndicated content for which the user is authorized.

User device 30, 32, 34, 36 are client based devices (e.g., workstations) through which users (e.g., members of the place) may use a browser to navigate to the place provided through collaborative server 20. User devices 30, 32, 34, 36 may also include a syndicated content reader or aggregator (e.g., an RSS reader) for subscribing to and reading syndicated content from the place. The syndicated content reader or aggregator may be implemented in a variety of ways, such as a browser plug-in, a browser bookmark application, an e-mail plug-in, or a stand-alone application. For instance, the syndicated content reader may be Mozilla Firefox, or FeedReader.

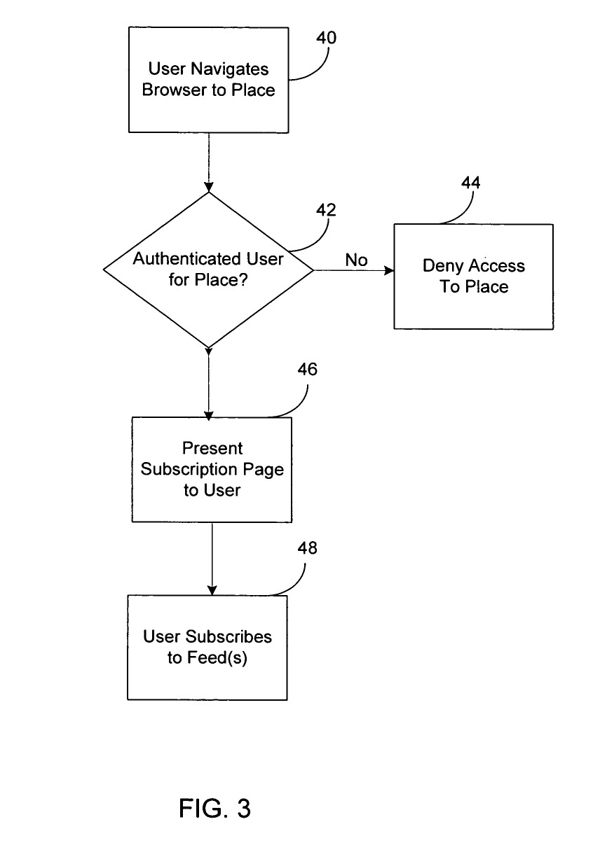

FIG. 3 is an operational flowchart of an illustrative process for a user to subscribe to syndicated content from a collaborative workspace, in accordance with an embodiment of the present invention. Initially a user, by way of a syndicated content reader/aggregator (e.g., RSS reader) or a browser (which may be invoked via the RSS reader) running on a client device (e.g., client 30) navigates to a place provided by the collaborative computing environment (step 40).

RSS engine 22 then confirms according to application/access control module 24 whether the user is an authenticated user for the workplace (step 42). For instance, application/access control module 24 may confirm whether the user has already signed into the workplace. If the user has not yet signed in, then authentication/access control module 24 executes a sign-on protocol (e.g., via a secure socket), for example, requiring the user to enter a password. In the event that the user is not a valid user of the place, the user is denied access (step 44).

In any event that the user is authenticated as a valid user, then the place presents the user with a webpage providing for the reader/aggregator to subscribe to one or more feeds provided by the place (step 46). As noted above, in some embodiments, a single channel (feed) delivers all syndicated content for the place, while in other embodiments the place may have several different feeds, for example, associated with different resources (e.g., Documents, workflow, etc.). In the latter case, in accordance with some implementations of the present invention, a user will only be presented with channels for which the user is authorized to subscribe.

The user then subscribes to a channel (or possibly more than one channel) for receiving syndicated content (step 48) according to the particular steps provided for by the RSS reader (e.g., dragging an RSS button into the RSS reader, copying the feed URL and pasting it into the reader's new feed/channel dialog, etc.).

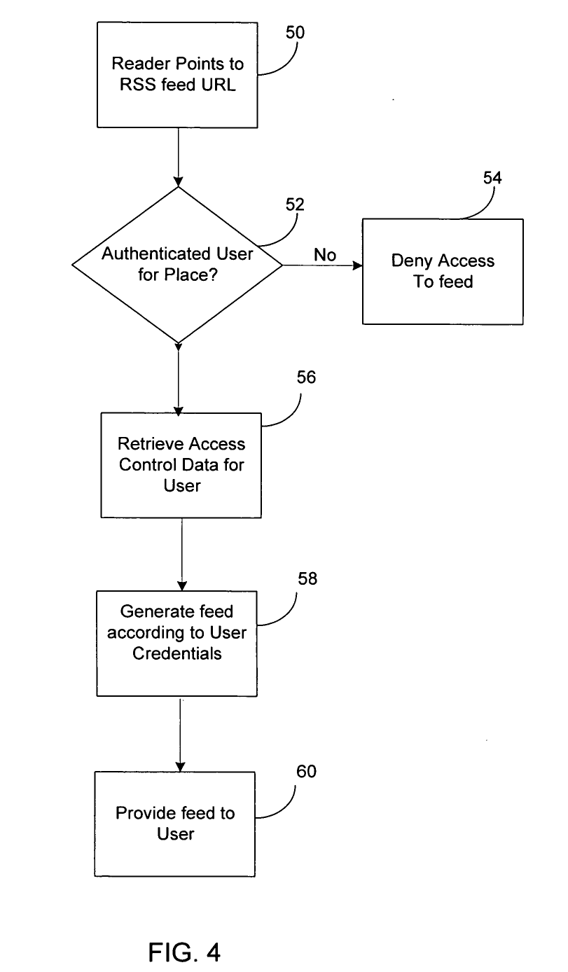

FIG. 4 is a flowchart of an illustrative process for providing syndicated content from a collaborative workspace, with the syndicated content being filtered according to user credentials, in accordance with some embodiments of the present invention. In this process, the user may be subscribed (e.g., by the process of FIG. 3) to content syndication (e.g., one or more RSS feeds) provided by the place. More specifically, the reader/aggregator running on the user's client device may be subscribed to a content syndication feed provided by the place. The user, however, need not be subscribed to content syndication provided by the place to obtain syndicated content from the place, as a user (whether or not subscribed) may navigate to a syndicated content feed provided by the place.

Reader/aggregator running on the user's client device is pointed to the RSS feed of the place (step 50). Such pointing may be invoked automatically by the reader/aggregator (e.g., periodically), or may be invoked by the user. Accordingly, an HTTP request for the feed URL is transmitted to collaborative server 20.

Upon collaborative server 20 receiving the request, RSS engine 22 confirms according to application/access control module 24 whether the user is an authenticated user for the workplace (step 52). For instance, application/access control module 24 may confirm whether the user has already signed into the workplace. If the user has not yet signed in, then authentication/access control module 24 executes a sign-on protocol (e.g., via a secure socket), for example, requiring the user to enter a password. In the event that the user is not a valid user of the place, the user is denied access to the feed (step 54).

In the event that the user is authenticated as a valid user, authorization/access control module 24 reads any data that may be stored on database 26 concerning the access rights and/or other privileges that the user may have in the space, and provides that data to RSS engine 22 (step 56). It may be understood that such data may be set forth according to rights (e.g., identifying content in the place that the user can access) and/or according to restrictions (e.g., identifying content in the place that the user cannot access) for the identified user, and such access rights may depend on any role(s) assigned to the identified user. As noted above, such data may be represented in the form of one or more access lists or other data structures, which may be indexed according to user identification. The access control information applicable to the user in the place may be referred to as the user's credentials.

RSS engine then generates an RSS feed having content that depends on the user's credentials (step 58). In accordance with an embodiment of the present invention, RSS engine generates such a credential dependent RSS feed by reading only the content stored on database 26 that is content the user has access to based on the user's credentials. RSS engine reads that content and generates an RSS formatted XML-based feed. Similarly, in an alternative implementation, RSS engine may maintain (e.g., locally or within database 26) a current RSS formatted content for the place, and RSS engine may generate an RSS feed by reading only the RSS formatted content that the user is allowed to access.

It may be understood that any process of generating syndicated content (e.g. an RSS feed) that may be a subset of the available syndication content in the place may be referred to herein as filtering of syndicated content; as such, it is understood that filtering, as used herein, is not limited to selecting available content and then removing a part of that content, but may also include a process by which only the content to be provided to a particular user is selected (e.g., without first reading and removing other content) based, at least in part, on one or more user credentials.

It may also be understood that the filtering process may have varying degrees of granularity or selectivity depending on the implementation. For instance, RSS feeds may be filtered on a tool/resource level (e.g., document folder, work approval process, etc.), or on a sub-tool/resource level (e.g., part of a document folder or a sub-folder, or part of a work approval process).

RSS engine 22 transmits the RSS feed to the user's client device via HTTP server 28 (step 60). The user, via reader/aggregator, can then select the channel (feed), allowing the titles (e.g., headline) of the syndicated content items in the feed to be viewed. Upon clicking on or otherwise selecting a title, the reader may display the content of the page for the link associated with that title; that is, the reader may include a built-in web browser window which is navigated to the link. As may be appreciated, that link may be a link to content within the place, although it may also be a link to a site external to the place (e.g., a public website).

Accordingly, in view of the foregoing illustrative embodiments, it may be appreciated that the collaborative computing environment represented by the system depicted in FIG. 2 thus allows for a user to be notified of and review new or modified content (e.g., document, workflow process requiring action, etc.), and in some embodiments also respond to content, without navigating the user's browser to the place. That is, to browse content newly created or modified within the place, a user (e.g., member) of a place may navigate the user's browser to the place, sign in if the user has not already done so, and then review or access content to which the user has access or other privileges (e.g., read only). In accordance with embodiments of the present invention (such as those described above), however, a user may read or access new or modified content at the place without navigating to the place, but instead by using a syndicated content reader. Thus, RSS readers can be pointed to the collaborative place, and content may be accessed in a secure manner according to user credentials. Accordingly, although a common RSS channel (feed) for the secure place is polled or otherwise accessed by each user's RSS reader, each user receives syndicated content (e.g., an RSS feed) that depends on the user's credentials. That is, in accordance with the present invention, the place provides secure syndicated content to a user.

In some embodiments of the present invention, the place may be configured to provide separate RSS feeds according to a set of known authorization levels for the users of the place. Accordingly, upon each user subscribing to or otherwise accessing the RSS feed(s), RSS engine 28 will only display to the user, or otherwise only allow the user to select, syndicated content feeds that contains only content that the user is authorized to receive. Thus, in some such embodiments, it may not be necessary for the RSS engine to authenticate user credentials upon subsequent polling of the RSS feed by the user's RSS reader, as a user is only capable of subscribing to one or more distinct RSS feeds that exclusively provides content for which the user is authorized.

It will also be understood that while, as described above, content syndication is provided according to user credentials, in some embodiments additional factors (e.g., the content of the syndicated content) may also be used in the filtering process.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above as such variations and modification are intended to be included within the scope of the invention.

What is claimed is:

1. A method for facilitating delivery of syndicated content to a user of a secured collaborative place in a collaborative computer environment, the method comprising:
receiving a request for syndicated content; and
providing syndicated content based on at least one credential associated with the user, said syndicated content being associated with the secured collaborative place.

2. The method according to claim 1, further comprising authenticating the user prior to providing syndicated content.

3. The method according to claim 1, wherein said at least one credential includes the identity of the user.

4. The method according to claim 1, wherein said at least one credential is based on a role assigned to the user in the secured collaborative place.

5. The method according to claim 1, wherein said at least one credential includes only the identity of the user.

6. The method according to claim 1, wherein said providing syndicated content is also based on the content of the syndicated content to be delivered to the user.

7. The method according to claim 1, wherein said providing to the user syndicated content is based exclusively on the at least one credential.

8. The method according to claim 1, wherein the request is received from an aggregator running on a client device associated with the user.

9. The method according to claim 1, wherein providing syndicated content includes selectively reading a database according to the at least one credential, said database having content associated with the secured collaborative place.

10. The method according to claim 1, further comprising receiving a second request for delivery of content associated with said syndicated content provided to the user, said second request including a link to a location within the secured collaborative place.

11. The method according to claim 1, wherein the syndicated content is generated according to at least one of the following associated with the secured collaborative place: new documents within a precedent time period; collaborative places that the user has access to; documents within a specific folder in the secured collaborative place; to-do tasks within the secured collaborative place; calendar of events within the secured collaborative place; and emails received by the secured collaborative place.

12. The method according to claim 1, wherein providing syndicated content includes providing the syndicated content to the user.

13. The method according to claim 1, wherein providing syndicated content based on at least one credential associated with the user comprises, in response to the request, filtering syndicated content available on the secured collaborative place according to the at least one credential.

14. A computer program product comprising a computer program embodied on at least one computer readable medium, the computer program when executed being operative in performing a method for facilitating delivery of syndicated content to a user of a secured collaborative place in a collaborative computer environment, the method comprising:
receiving a request for syndicated content; and
providing syndicated content based on at least one credential associated with the user, said syndicated content being associated with the secured collaborative place.

15. The computer program product according to claim 14, the method further comprising authenticating the user prior to providing syndicated content.

16. The computer program product according to claim 14, wherein said at least one credential includes the identity of the user.

17. The computer program product according to claim 14, wherein said at least one credential is based on a role assigned to the user in the secured collaborative place.

18. The computer program product according to claim 14, wherein said at least one credential includes only the identity of the user.

19. The computer program product according to claim 14, wherein said providing syndicated content is also based on the content of the syndicated content to be delivered to the user.

20. The computer program product according to claim 14, wherein said providing syndicated content is based exclusively on the at least one credential.

21. The computer program product according to claim 14, wherein the request is received from an aggregator running on a client device associated with the user.

22. The computer program product according to claim 14, wherein providing the syndicated content includes selectively reading a database according to the at least one credential, said database having content associated with the secured collaborative place.

23. The computer program product according to claim 14, the method further comprising receiving a second request for delivery of content associated with said syndicated content provided to the user, said second request including a link to a location within the secured collaborative place.

24. The computer program product according to claim 14, wherein the syndicated content is generated according to at least one of the following associated with the secured collaborative place: new documents within a precedent time period; collaborative places that the user has access to; documents within a specific folder in the secured collaborative place; to-do tasks within the secured collaborative place; calendar of events within the secured collaborative place; and emails received by the secured collaborative place.

25. The computer program product according to claim 14, wherein providing syndicated content includes providing the syndicated content to the user.

26. The computer program product according to claim 14, wherein providing syndicated content based on at least one credential associated with the user comprises, in response to the request, filtering syndicated content available on the secured collaborative place according to the at least one credential.
